(19) United States
(12) Patent Application Publication
(10) Pub. No.: US 2013/0074658 A1
(43) Pub. Date: Mar. 28, 2013

(54) Adjustable Socket Wrench Extension

(71) Applicant: Peter Bowens, Riverview, FL (US)

(72) Inventor: Peter Bowens, Riverview, FL (US)

(21) Appl. No.: 13/240,652

(22) Filed: Sep. 22, 2011

(51) Int. Cl. B25B 17/00; B25B 23/00

(52) U.S. Cl. 81/57.22; 81/57.26; 173/1

(57) ABSTRACT

An adjustable socket wrench extension includes a gear train of meshing gears that translates torque from a first end to a second, opposite end; a female drive fitting to apply the torque from the socket wrench to the first end of the gear train; a male drive fitting to provide the torque to a socket at the second end; a frame that retains the gear train in a plane; a plurality of locking plates on the first side of the frame; a locking tab on the first side of the frame to retain the locking plates in a relative orientation; and a pushbutton on the second side of the frame to temporarily disengage the locking tab from the locking plates so that the relative orientation between the plates may be changed, thereby changing the shape of the device.

### BACKGROUND OF THE INVENTION

The present invention generally relates to hand tools and more specifically to an adjustable socket wrench extension.

A standard socket wrench or ratchet wrench has a handle with a male drive fitting, such as ⅜″, and a set of sockets each with a matching female drive fitting. Sockets come in different increments of inches or metric sizes, usually shaped to grasp the head of a bolt or nut. If the bolt is difficult to access, a ratchet wrench may not have sufficient room to adequately ratchet until it clicks, and the wrench and will not work.

It would be desirable to have a tool for use with one hard-to-ratchet bolts with limited space. It would be desirable for the tool to be easy to access and versatile, so that the tool can switch abilities and different heads, change its shape, and have the ability to add more sections to make it longer and give more degrees of motion.

### SUMMARY OF THE INVENTION

In one aspect of the present invention, a device includes a gear train of meshing gears that translates a torque from a first end to a second, generally opposite end; a frame having a plurality of locking plates that retain the gear train in a plane; and a locking mechanism that disengages and then reengages the locking plates so that the relative orientation of the gears may be changed, thereby changing the shape of the device.

In another aspect of the present invention, a device for transferring a torque from a socket wrench to a socket includes a gear train of meshing gears that translates the torque from a first end to a second, opposite end; a female drive fitting adapted to apply the torque from the socket wrench to the first end of the gear train; a male drive fitting adapted to provide the torque to a socket at the second end of the gear train; a frame having a first side and a second side generally opposite the first side, that retains the gear train in a plane; a plurality of locking plates on the first side of the frame; a locking tab on the first side of the frame to retain the locking plates in a relative orientation; and a pushbutton on the second side of the frame to temporarily disengage the locking tab from the locking plates so that the relative orientation between the plates may be changed, thereby changing the shape of the device.

In yet another aspect of the present invention, a method for transferring a torque from a socket wrench to a socket includes utilizing a gear train of meshing gears to translates the torque from a first end to a second, opposite end; utilizing a female drive fitting to apply the torque from the socket wrench to the first end of the gear train; utilizing a male drive fitting to provide the torque to a socket at the second end of the gear train; utilizing a frame having a first side and a second side generally opposite the first side, to retain the gear train in a plane; utilizing a locking tab on the first side of the frame to retain a plurality of locking plates on the first side of the frame in a relative orientation; and utilizing a pushbutton on the second side of the frame to temporarily disengage the locking tab from the locking plates so that the relative orientation between the plates may be changed, thereby changing the shape of the device.

### BRIEF DESCRIPTION OF THE DRAWINGS

FIG. 1 depicts an exploded view of an embodiment of the present invention;

FIG. 2 depicts a side view of the embodiment of FIG. 1 assembled;

FIG. 3 depicts an exploded view of a head release assembly according to the embodiment of FIG. 1;

FIG. 4 depicts a head attachment according to the embodiment of FIG. 1;

FIG. 5 depicts a wrench gear according to the embodiment of FIG. 1;

FIG. 6 depicts the embodiment of FIG. 1 adjusted to a first shape; and

FIG. 7 depicts the embodiment of FIG. 1 adjusted to a second shape.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a socket wrench extension with adjustment buttons that allow a user to change the shape of the extension.

Embodiments of the present invention may allow a standard socket wrench to apply torque to a female drive fitting on one side of the device (the “top”). The device may use a gear train of meshing, side-by-side gears to translate the force sideways to a second location, where it applies the torque to a male socket drive fitting (on the “bottom”). Since the wrench will be outside of the bolt's blocked accessibility area, the handle can make a full turn, or at least will have more freedom than without the device. A ratchet wrench, which would otherwise only be able to ratchet one click at a time, may be able to function by turning outside of the bolt's blocked accessibility area.

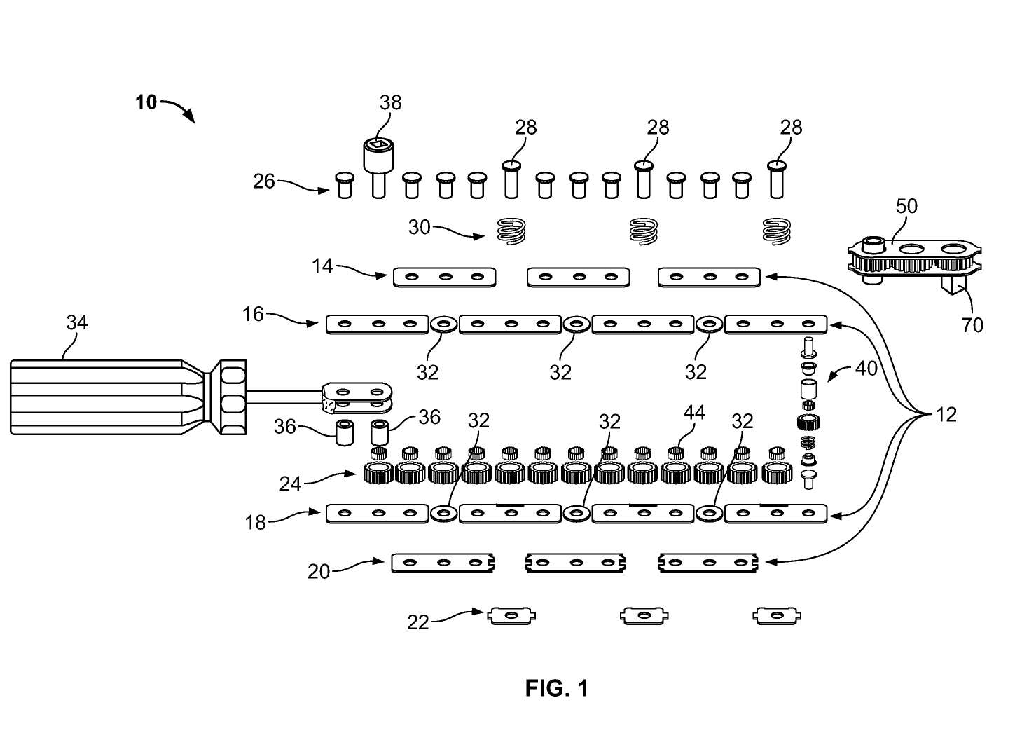

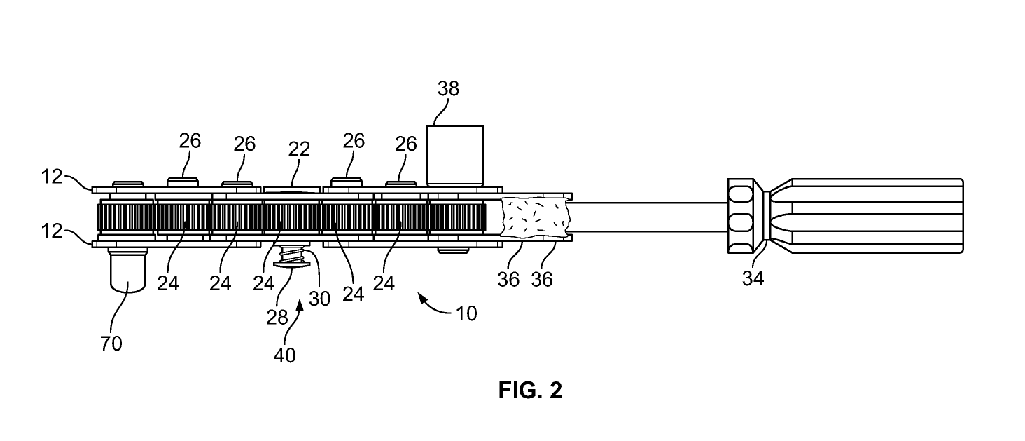

As depicted in FIGS. 1 and 2, an embodiment of an adjustable socket extension 10 may include a frame 12 made of plates, including outer retainer plates 14, inner retainer plates 16, inner locking plates 18, and outer locking plates 20. The outer locking plates 20 are held in various positions relative to each other with locking tabs 22. Each drive gear 24 may be held to the plates by a pin 26 through its center axis and may have needle bearings 44 to reduce friction. For gears attached to the outer plates 14 and 20, there may be spacer washers 32 between the appropriate inner plates 26 and 18 to keep the gears inline or side-by-side or both. A locking mechanism having spring-loaded pushbuttons 28 with springs 30 may be attached to the inner plates, and may allow a user to temporarily release the locking tabs 22, so the user can change the shape of the frame 12 by adjusting the relative positions of adjacent plates. The device 10 may have a counter-pull handle 34 held with handle pins 36 at one end for counter pull while ratcheting high torque bolts, and a socket head 70 at the opposite end for attaching to a matching socket. A wrench attachment 38 near the handle may be rotatably connected to the drive gears 24 to allow the user to attach a socket wrench and apply torque. More plate-and-gear sections may be added to the device to increase its length. There may be bearings and washers between various moving parts. Embodiments may include a pushbutton for the locking mechanism on the same side as the wrench drive fitting (the top) with the locking tab on the bottom, as depicted in FIG. 1, or the pushbutton may be on the bottom with the locking tab on the top, as depicted in FIG. 2. As depicted in FIG. 1, a head attachment 50 may have the socket head 70, and may be releasably attached to the device with a head release assembly 40 so the user can change the head.

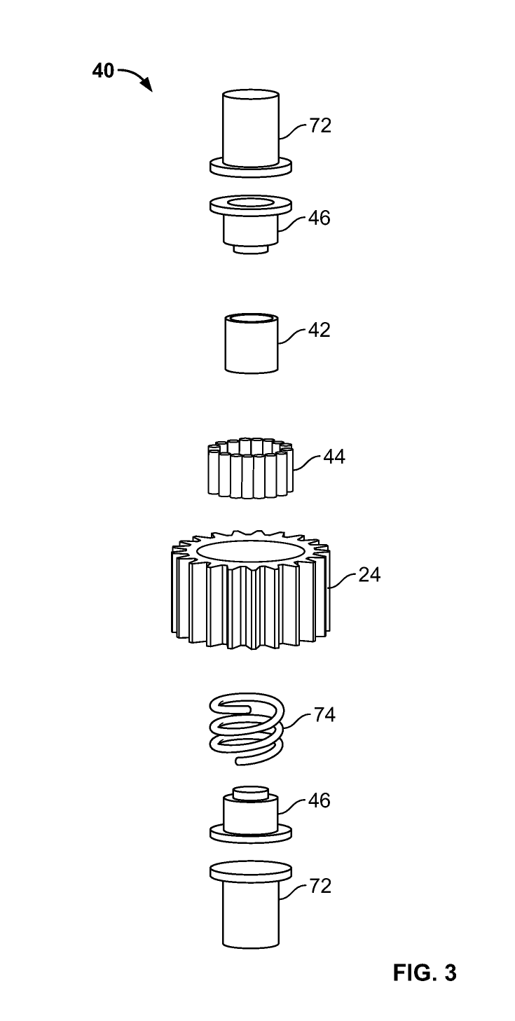

As depicted in FIG. 3, an embodiment of a head release assembly 40 for a head attachment may include push buttons 72 with springs 74 that pass through the gears 24. The head release assembly 40 may include a strengthening sleeve 42, needle bearings 44 between the gear 24 and the sleeve 42, and push button retainers 46 to help position the push buttons 72. The head release assembly 40 may allow a user to quickly attach and detach a head attachment.

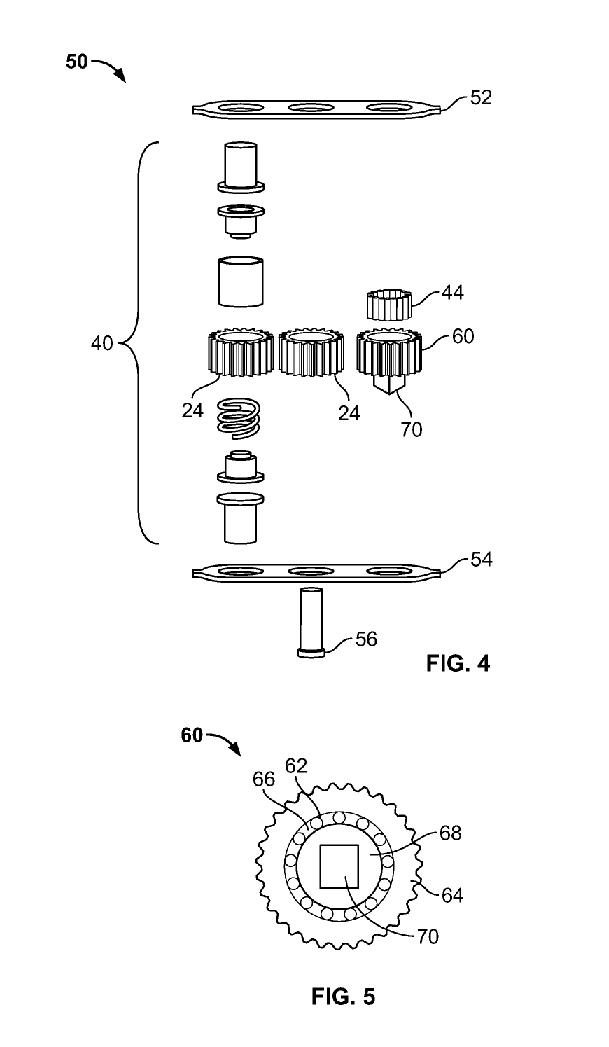

As depicted in FIG. 4, an embodiment of a head attachment 50 may include an upper retaining plate 52 and a lower retainer plate 54 that hold drive gears 24 and wrench gear 60 with interior needle bearings 44 and a socket head 70. A head release assembly 40 and attachment pin 56 may releasably retain the head attachment 50 to an end of the adjustable socket wrench extension opposite from the wrench attachment.

As depicted in FIG. 5, an embodiment of a wrench gear 60 may include an outer ring 64, and an inner disc 68, with a ball bearing channel 66 that retains ball bearings 62 between the outer ring 64 and inner disc 68 to enter the gear on the retaining plates. A socket head 70 may extend down from the inner disc 68.

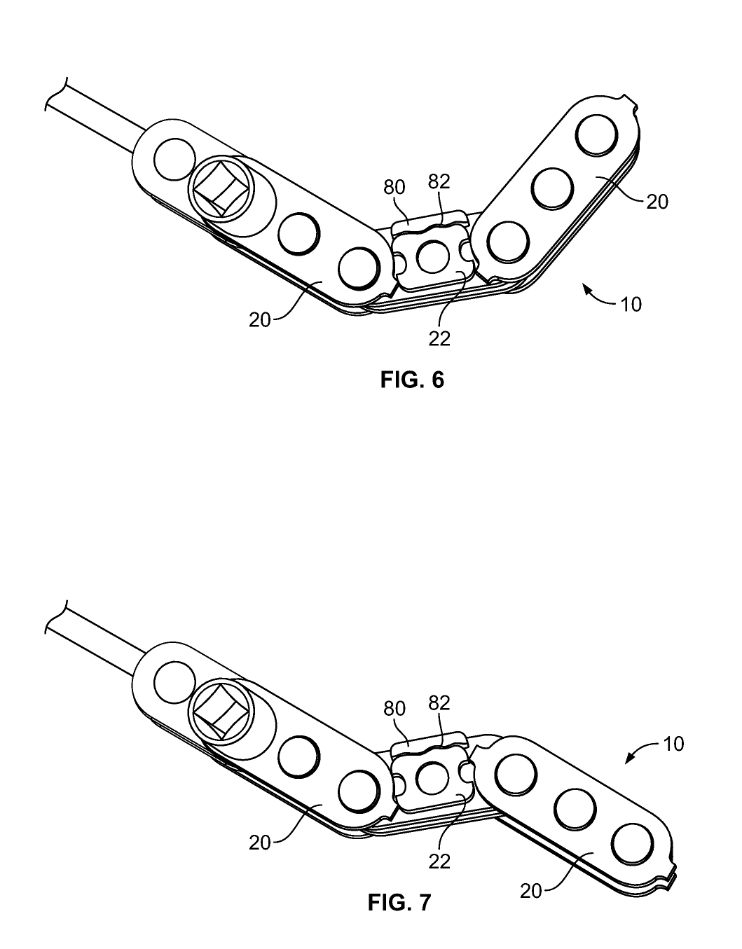

As depicted in FIGS. 6 and 7, an embodiment of an adjustable ratchet extension 10 may change its shape utilizing locking tabs 22 by adjusting the relative positions of adjacent outer locking plates 20. Embodiments may include a tab retaining wall 80 to hold the locking tab 22 in a fixed orientation when it is engaged. The retaining wall 80 and locking tab 22 may have a shaped edge 82, so that the locking tab 22 will only engage when it is in the correct position. Embodiments may include outer locking plates 20 having notches to retain a tab on the locking tabs 22, as depicted in FIG. 1, or may have plates 20 with tabs and locking tabs 22 with notches, as depicted in FIGS. 6 and 7.

An embodiment of a tool may allow a wrench that would only be able to ratchet a bolt one click at a time to allow a full turn of the ratchet outside of the bolt's blocked accessibility. Embodiments may provide the ability to switch out heads based on what is required for a job whether it is for torque, wrenching or speed. A tool may be lengthened for extended reaching as well.

Embodiments of a tool may be made of plates, tabs for adjustability which are welded to some of the pins, locking plates for a way to stabilize the form of the shape to which the user will adjust, gears for being able to extend the tool, rivets to hold the gears and springs, sleeves for strength, a handle for counter pull while ratcheting high torque bolts, spacing washers for keeping the gears tightly together when the overlap of plates leaves a gap, springs for returning adjustment buttons to their lock position, bearings for the gears, and buttons for ease of use to the user of the tool.

Embodiments may be provided in different shapes to help access different bolts.

To use an embodiment of a tool, a user may push a button or buttons on each side for the heads, to be able to switch out different heads for speed, wrenching, or torque. More sections may be added for lengthening. The adjustment may be made with a push of a button on the top side to get the shape needed for the required hard-to-ratchet bolt.

To make an embodiment, a tool may have springs of two sizes, rivets of two lengths made of hardened steel, and plates are flat, sturdy, and CNC cut. The gears may be in two different sizes based on the function of the gear and made from strong hardened steel. A counter-pull handle may be made of plastic, with a steel shaft hardened for strength. The pins may be welded to the locking tabs. The sleeves, and the needle and ball bearings may be steel. The spacer washers may be good steel with an appropriate thickness for the retaining and locking plates. The buttons may be made of steel. Each gear may be approximately ⅝″ in diameter and the center hole may be roughly ½″ in diameter to accommodate needle bearings. The tool may be ¾″ wide and ¾″ tall. The handle may be roughly 5″ long. The pins may be ⅜″ in diameter, to accommodate a standard ⅜″ ratchet. Embodiments may include a ½″ or a ¼″ ratchet extension.

I claim:

1. A device comprising:
a gear train of meshing gears that translates a torque from a first end to a second, generally opposite end;
a frame having a plurality of locking plates that retain the gear train in a plane; and
a locking mechanism that disengages and then reengages the locking plates so that the relative orientation of the gears may be changed, thereby changing the shape of the device.

2. The device of claim 1, further comprising:
a first drive fitting to apply the torque to the first end of the gear train; and
a second drive fitting to provide the torque from the second end of the gear train.

3. The device of claim 1, wherein the first drive fitting is a female drive fitting adapted to receive the torque from a socket wrench.

4. The device of claim 1, wherein the second drive fitting is a male drive fitting adapted to provide the torque to a socket.

5. The device of claim 1, wherein there is an odd number of gears in the gear train so that the torque is provided at the second end in same direction that the torque is applied at the first end.

6. The device of claim 1, wherein the locking mechanism includes a locking tab that engages with the locking plates and retains the plates in a first relative orientation, disengages with the locking plates so that the plates may be transitioned to a second relative orientation, and then re-engages with the locking plates to retain the plates in the second relative orientation.

7. The device of claim 6, further comprising a retaining wall that holds the locking tab in a fixed orientation when the locking tab is engaged with the locking plates.

8. The device of claim 1, wherein the frame has a first side and a second side generally opposite the first side, the first side includes the plurality of locking plates, and the second side includes a plurality of retaining plates that correspond to the locking plates.

9. The device of claim 8, wherein each gear is retained between corresponding plates by a pin through a center axis of the gear.

10. The device of claim 8, wherein the locking mechanism includes a locking tab on the first side of the frame to retain the locking plates in a relative orientation, and a pushbutton on the second side of the frame to temporarily disengage the locking tab so that the relative orientation between the plates may be changed.

11. The device of claim 1, wherein the frame has a side that includes an outer layer having the locking plates and a locking tab between the locking plates, and an inner layer having inner plates with a spacer between the inner plates, so that the inner plates and spacer retain the gear train in a plane, and the relative orientation between the inner plates and locking plates may be adjusted utilizing the release mechanism.

12. The device of claim 1, wherein the frame includes a plurality of frame sections, each frame section having a gear train, a locking plate, and a locking mechanism, so that the length of the device may be extended by adding additional frame sections.

13. The device of claim 1, further comprising:
a head attachment having a socket head to provide the torque from the second end of the gear train; and
a head release assembly to releasably attach the head attachment to the gear train.

14. The device of claim 1, further comprising:
a handle near the first end of the gear train, for a user to provide counter-pull.

15. A device for transferring a torque from a socket wrench to a socket, comprising:
a gear train of meshing gears that translates the torque from a first end to a second, opposite end;
a female drive fitting adapted to apply the torque from the socket wrench to the first end of the gear train;
a male drive fitting adapted to provide the torque to a socket at the second end of the gear train;
a frame having a first side and a second side generally opposite the first side, that retains the gear train in a plane;
a plurality of locking plates on the first side of the frame;
a locking tab on the first side of the frame to retain the locking plates in a relative orientation; and
a pushbutton on the second side of the frame to temporarily disengage the locking tab from the locking plates so that the relative orientation between the plates may be changed, thereby changing the shape of the device.

16. A method for transferring a torque from a socket wrench to a socket, comprising:
utilizing a gear train of meshing gears to translates the torque from a first end to a second, opposite end;
utilizing a female drive fitting to apply the torque from the socket wrench to the first end of the gear train;
utilizing a male drive fitting to provide the torque to a socket at the second end of the gear train;
utilizing a frame having a first side and a second side generally opposite the first side, to retain the gear train in a plane;
utilizing a locking tab on the first side of the frame to retain a plurality of locking plates on the first side of the frame in a relative orientation; and
utilizing a pushbutton on the second side of the frame to temporarily disengage the locking tab from the locking plates so that the relative orientation between the plates may be changed, thereby changing the shape of the device.
